(19) United States
(12) Patent Application Publication
(10) Pub. No.: US 2008/0280528 A1
(43) Pub. Date: Nov. 13, 2008

(54) Varroa mites control entrance (VMCE)

(75) Inventor: Karen Anne Wassmer Mudd, Jacksonville, FL (US)

Correspondence Address: Karen Anne Wasmer, 2004 Orange Picker Road, Jacksonville, FL, 32223, US

(73) Assignee: Karen Ann Wassmer, Jacksonville, FL (US)

(21) Appl. No.: 12/011,448

(22) Filed: Jan. 28, 2008

Related U.S. Application Data
(60) Provisional application No. 60/928,104, filed on May 8, 2007.

(51) Int. Cl. A01K 47/06; A01K 51/00

(52) U.S. Cl. 449/2; 449/3

(57) ABSTRACT

A method and apparatus for removing of Varroa Mites from Honeybees as the Honeybee enter and exit the hive entrance.

### CROSS REFERENCE TO RELATED APPLICATIONS

This application claims the benefits of provisional patent application, the content of which is incorporated by referenced: Varroa Mite Control Entrance (VMCE).

### REFERENCE CITED UNITED STATES PATENTS

Application of Provisional Utility Patent: 60/,928,104

Application Filing Date: May 8, 2007

### UNITED STATES PATENT DOCUMENTS SEARCH

| Patent | Filing | | |
|---|---|---|---|
| Number | Date | Inventor | Relationship of |
| 4,876,731 | 19SEP89 | Willard | Process for detecting parasite |
| | | | infestion for package bees |
| 5,069,651 | 03DEC91 | Arndt | Method and Apparatus for |
| | | | removing parasites from honeybee |
| | | | using heat and electric fan |
| 6,468,129 | 22OCT02 | Griffith | Bottom board reducing parasite |
| | | | infestation |
| 6,702,645 | 09MAR04 | Vanderpool | Separating parasites from |
| | | | honeybees using compressed |
| | | | air to dislodge parasites |

### STATEMENT REGARDING FEDERALLY SPONSORED RESEARCH OF DEVELOPMENT

The request for this patent is not sponsored by any federal sponsored research or development program.

### REFERENCE TO SEQUENCE LISTING, A TABLE, OR A COMPUTER PROGRAM LISTING COMPACT DISC APPENDIX

No Computer Program Listing or Compact Disc is submitted with this patent application.

### BACKGROUND OF THE INVENTION

Over the past three decades, ever since Varroa Mites (also known as Varroa Jacobsoni, Varroa Destructor, Varroa mellifera) were discovered in the United States, they have plagued Apiary honey production. This infestation has affected the commercial, hobbyist and sideliner apiaries through out the United States. Varroa Mites are very destructive to the hive. They enter the hive by attaching themselves to adult Honeybees and are thereby carried into the hive. Adult Varroa Mites lay eggs in brood cells with new, unhatched bee larva, causing deformities to new bees and eventually causing death to the young bee and to the adult host bees. There are numerous research articles on current methods of combating the Varroa Mites populations and methods for detecting Varroa Mite infestation. These methods include non-organic and organic methods for detection and removal of the Varroa Mites.

Some of the non-organic methods include “Api-guard” and “Mite Away” chemicals, which cause the Honeybees to go into their cleaning hygiene mode. Through this method, the Honeybees will dislodge the Varroa Mites causing them to fall off the bee and land in the bottom of the hive. Varroa Mites like any other pest/insect can and will eventually become immune to these chemicals according to research. The Varroa Mites that are dislodged and land in the bottom of the hive have the ability to climb back up in the brood frames and lay eggs in brood cells. These chemicals used in conjunction with screen bottoms have some reduction of re-infestation of the hive.

Organic methods include confectioned/powered sugar sprinkled onto the Honeybee while they are in the frames inside of the hive. Similarly, Honeybees go into their cleaning hygiene mode to remove the powered sugar from their bodies, causing the Varroa Mites to be dislodged and fall off the Honeybee and into the bottom of the hive. Again, the Varroa Mites can re-infest the hive by climbing back up on to the frame of brood. The powdered sugar methods used with a screen bottom board also have some reduction of re-infestation of the hive and frames of brood.

Both of these methods are more effective when used with a screen bottom board and Westel Small Hive Beetle trap or Sticky Bottom Board. Using with screen bottom board, the Varroa Mites that fall through the screen bottom board and land in the Westel Small Hive Beetle trap greatly reduces the re-infestation of the hive. The Sticky Bottom Board fits through the hive opening with a plastic mesh screen to prevent bees from becoming stuck onto the sticky adhesive. The Varroa Mites fall off the Honeybee and through the mesh screen becoming stuck to the sticky board preventing re-infestation of the hive. The draw back to Sticky Bottom Board is it has to be replaced at regular intervals and especially after it has rained. Rain reduces the effectiveness of the sticky bottom board and the corners have known to curl up making the removal of the board more difficult.

Current method for detecting Varroa Mites infestation is:

Ether/Alcohol Roll Test—The beekeeper pours ether/alcohol into ajar with fifty to a hundred Honeybees then rolls the jar. The Varroa Mites stick onto the side of the jar and the beekeeper counts the number of Varroa Mites in the sample. Of course, this method kills the Honeybees in the sample as well as the Varroa Mites.

The Powdered Sugar Roll Test—The beekeeper puts fifty to a hundred Honeybees in jar with a screen mesh lid. The beekeeper adds powdered sugar and rolls the jar covering the honey bees with powered sugar. After the bees finish their cleaning, the beekeeper shakes the powdered sugar onto a piece of white paper or white poster board and counts the number of Varroa Mites. The Honeybees are not harmed and are returned to the hive.

The Powdered Sugar Frames Test—The beekeeper sprinkles powdered sugar on frames with a piece of poster board and inserts them through the hive entrance to catch the Varroa Mites that have fallen off of the Honeybees. The beekeeper waits approximately fifteen minutes, removes the poster board, and counts the number of Varroa Mites that have fallen onto the poster board.

The pathogens being passed on to the Honeybees from Varroa Mites is recognized as one possible cause for the Colony Collapse Disorder in Apiary yards across the country. The need to remove the Varroa Mites from Honeybees to ensure a healthy hive for pollination and honey production is clear.

### OTHER SELECTED REFERENCES

Aratanakul P, Burgett M. 1975. Varroa jacobsoni: A prospective pest of Honeybees in many parts of the world. Bee World 56: 119-121.
Crane E. 1979. Fresh news on the Varroa Mites. Bee World. 608: 8.
Cromroy H L. 1984. The Asian Honeybee Mites, a new threat to American beekeepers. Florida Extension Service. EYN-48. 4 p.
Kevan P G, Laverty T M, Denmark H A. 1990. Association of Varroa jacobsoni with organisms other than honey bees and implications for its dispersal. Bee World 7: 119-121.
Popa A. 1980. Agriculture in Lebanon. American Bee Journal 120: 336-367.
Ritter W. 1981. Varroa disease of the Honeybee Varroa mellifera. Bee World 62: 141-153.
Sanford M T. 2001. Introduction, spread and economic impact of Varroa Mites in North America. In: Mites of the Honey Bee. Hamilton, Ill.: Dadant & Sons. pp. 149-162.
Sanford M T. (1997). A history of varroa Mites in Florida, with discussion of controls. APIS http://apis.ufl.edu/threads/varroa.htm (May 2000).

### BRIEF SUMMARY OF THE INVENTION

A method and apparatus for removing of Varroa Mites from Honeybees. The device consists of two primary components: a brush and a metal receiving tray. The assembly is placed in front of the hive entrance. Honeybees past between the brush and the over a wire mesh screen cover on top of the metal receiving tray. Soft nylon bristles of the brush gently dislodge the Varroa Mites from the Honeybees. Varroa Mites fall off the Honeybees; pass through a wire mesh screen in the metal receiving tray and land onto contact paper with the adhesive side facing upward. This invention prevents the Varroa Mites from re-infesting the Honeybees or the hive. Over a prolonged period of time the Varroa Mite Control Entrance (VMCE) in place reduces the total population of Varroa Mites from the hive body.

### BRIEF DESCRIPTION OF THE SEVERAL VIEWS OF THE DRAWINGS

This invention is designed to greatly reduce Varroa Mites on Honeybees using no chemicals.

This invention has two main parts:

First, the Brush that is used to dislodge the Varroa mites from the Honeybees.

Second, the metal tray which the mite's fall into, preventing the Varroa Mites from crawling back up onto their hosts.

Together, they act to reduce or prevent the Varroa Mites from entering the hive body which reduces the parasitic effect on Honeybee larva that causes deformities in their young.

FIG. 1: The wire mesh screen that separates the Honeybees from coming in contact with the adhesive side of the contact paper. The wire mesh screen has approximately 2 mm-4 mm openings in the mesh. The overall size of the wire mesh screen is 12¼″ long by 2/¼″ wide by ¼″ deep.

FIG. 2: The metal receiving tray that is 12½′″ long by 2½″ wide and ¼″ deep. The metal receiving tray holds the contact paper with the adhesive side facing upwards.

FIG. 3: Shows FIGS. 1 and 2 assembled together. To assemble, place a strip of contact paper 12½″ in long by 2½″ wide into the bottom of the metal receiving tray (FIG. 2) with the adhesive side facing upwards. Then place the wire mesh screen (FIG. 1) into the metal receiving tray.

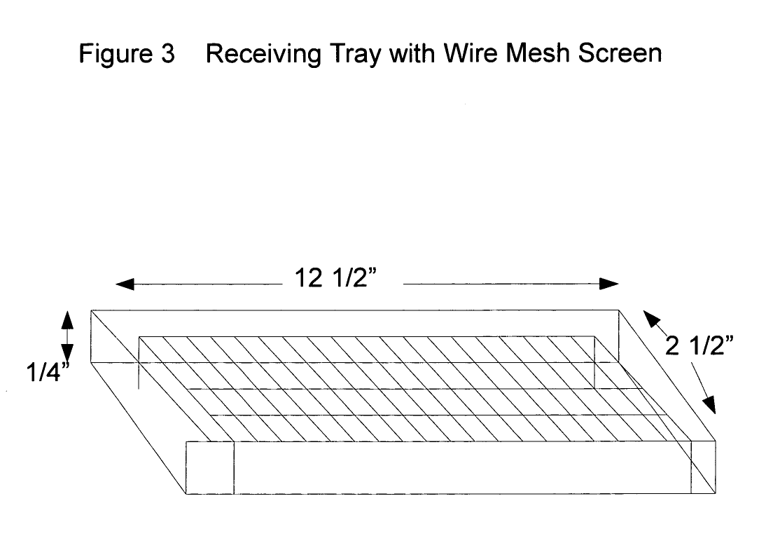

FIG. 4: The brush portion of the Varroa Mite Control Entrance (VMCE). The center section of the brush consists of five strips of wood that are 12¼″ in length and 7/16″ in width and ¾″ in height. In between each of these five strips of wood are ¾″ soft nylon polyester bristles. A ¼″ of the soft nylon polyester bristles is glued between the strips of wood with ½″ of bristles sticking below the bottom of the wood. On each end of the strips of wood is 7/16″ length by 2¼″ wide by ¾″ height. At the very end is piece of wood that is ¾″ in length by 2¼″ wide and 1¾″ tall. The overall dimension of the brush is 14¾″

FIG. 5: The metal top that fits over the top of the brush to protect the glue and polyester bristles from rain. This piece is 14¾″ long, by 2¼″ wide and ¾″ deep. It is glued onto the brush portion of the apparatus.

FIG. 6: Shows the completed assembly of the brush and tray of Varroa Mite Control Entrance (VMCE).

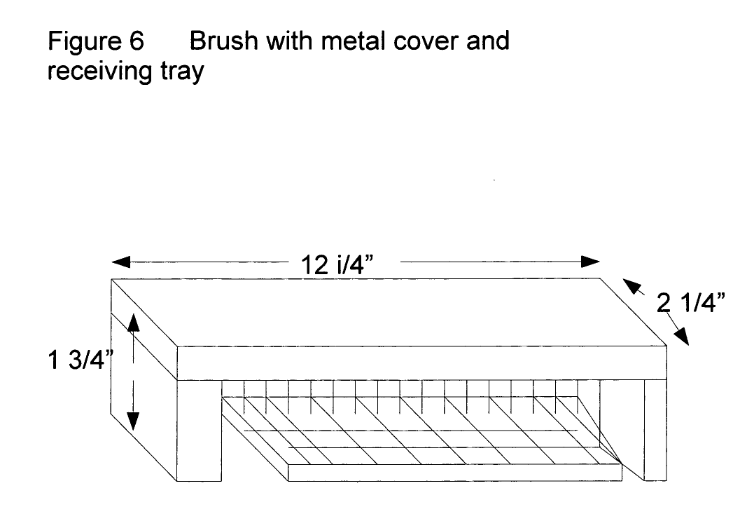

FIG. 7: Shows the Varroa Mite Control Entrance (VMCE) placed on the bottom board of the beehive in front of the entrance for the bee to enter and exit the hive.

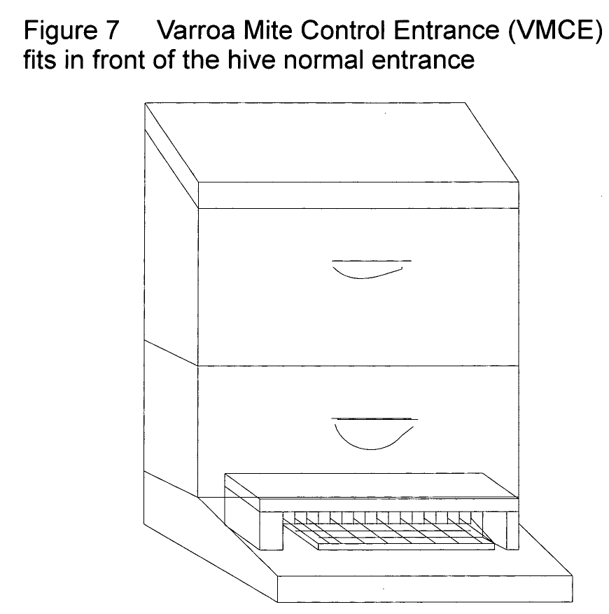

Method of Operation: As the Honeybees pass through the Varroa Mite Control Entrance (VMCE) the soft polyester bristles gentle dislodge the Varroa Mites from the top and back portions of the Honeybee. The Varroa Mites fall through the small wire mess into either oil or a sticky substance preventing the Varroa Mites from re-entering the hive body.

Goal of Invention: Reduction of Varroa Mite infestation in the hive body which reduces the infestation in Honeybee larva thereby reducing deformities in their young and increasing overall hive health and honey production.

### DETAILED DESCRIPTION OF THE INVENTION

The Varroa Mite Control Entrance (VMCE) is lightweight, easy to clean and can be left in place year around. The Varroa Mite Control Entrance does not require any electric or harmful chemicals making it environmentally friendly. Other inventions and methods are heavy; require electricity, heat, compressed air, or harmful chemicals. The Varroa Mite Control Entrance (VMCE), compared to other inventions, is more cost effect for large commercial Apiaries and is affordable for the hobbyist and sideliner Apiary yards as well.

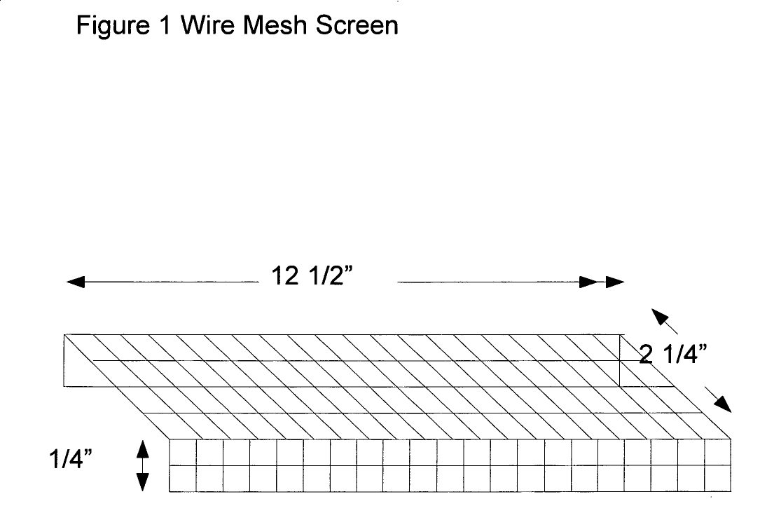

Constructing FIG. 1—The wire mesh screen that fits into the metal receiving tray: Using 2 mm-4 mm wire mesh screen cut to the length of 12¼″ by 2¾″ wide rectangle. Then bend the wire mesh screen down ¼″ on the two sides that are 12¼″ long. This makes the overall dimension of wire mesh screen 12¼ long by 2¼″ wide and ¼″ high.

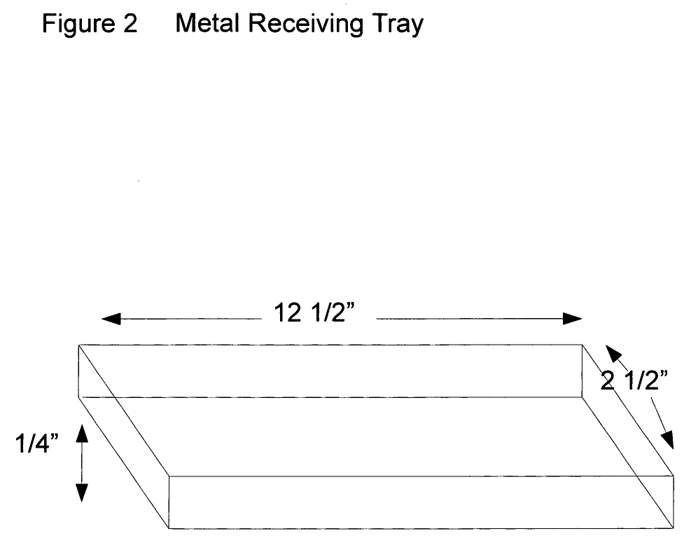

Constructing FIG. 2—The metal receiving tray: This piece is cut from a piece of galvanized aluminum into rectangle shape with the length of 13″ by 3″ wide. Down the long side of the Aluminum rectangle, bend the galvanized aluminum upward ¼″ along each of the sides. Cut a ¼″ slit into the side ¼″ from ends, then bend ¼″ of the galvanized aluminum upward at each end. Fold the galvanized aluminum to create the corners of the metal tray.

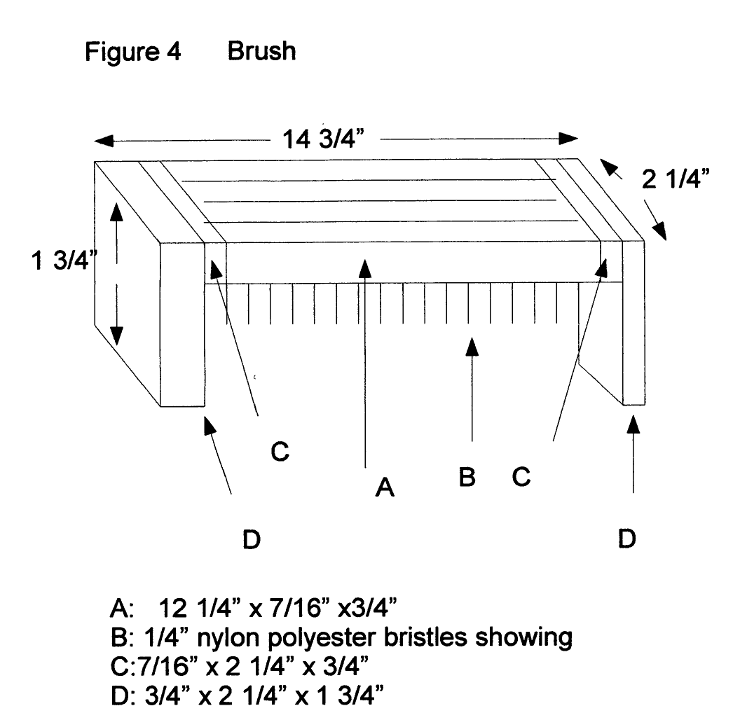

Constructing FIG. 4—The brush used to dislodge the Varroa Mites:

The following items are needed:
Five strips of wood that are each 12¼″ in length and 7/16″ wide and ¾″ deep.
Two strips of wood 7/16″ in length by 2¼″ in width by ¾″ in height.
Two pieces of wood that are ¾″ by 2¼″ by 1¾″
Wood glue
¼″ wide double sided tape
Soft nylon polyester paintbrush
Two C-clamps
Sheet metal bending jig
   First cut four pieces of the double sided tape 12¼″ long and cut ¾″ of the bristles off the soft nylon polyester paintbrush. Align the bristles from the paintbrush onto the tape, leaving ½″ of the bristle sticking past the adhesive portion of the tape. Repeat this process for the other three pieces of the double-sided tape. Now peel off the back side of the double sided tape and affix it to the lower portion of strip of wood that is 12¼″ long, add a bead of wood glue down the length of the strip of wood, place another strip of 12¼″ wood on top of the glue. Repeat this process until you have four rows of bristles between the five strips of 12¼″ strips of wood. Use C-clamps to hold the strips of wood together until the glue dries. Once the glue has dried remove the c-clamps and glue the 7/16″×2¼×¾″ pieces of wood to each end of the 12¼″ piece of wood, clamp until glue is dry. Finally, glue the last two-pieces of wood ( 3/4″×2¼″×1¾″).

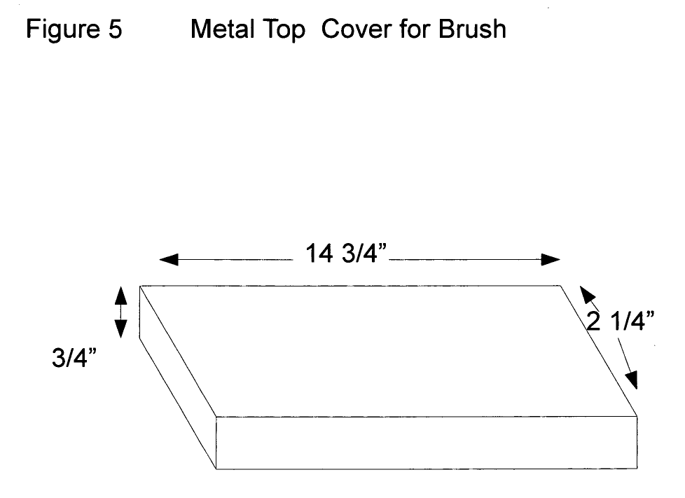

Constructing FIG. 5: Cut a piece of galvanized aluminum into a rectangle 16¼″ long by 4″ wide. Down the long side of the Aluminum rectangle, bend the galvanized aluminum downward ¾″ along each of the sides. Cut a ¾″ slit into the side ¾″ from ends then bend ¾″ of the galvanized aluminum downward at each end. Fold the galvanized aluminum to create the corners of the metal cover. Put beads of wood glue on the top and sides of the brush assembly and place the metal cover over the top of the brush.

Final assembly: Line the metal tray with contact paper with adhesive side face upward. Place the wire mesh screen into the tray. Place the brush and metal tray in front of the hive opening, pushing against the hive not to allow the Honeybees access between the hive and the brush.

1. What I claim as my invention is a method for removal and detection of Varroa Mites on Honeybees, which operates passively and uses no moving parts or harmful chemicals.

2. Honeybee wings are not damage by the soft nylon polyester bristles of the brush. The Honeybee is not exposed to adhesive side of the contact paper.

3. The apparatus is designed to be used for a prolonged period of time to reduce the number of Varroa Mites from the entering hive by removing Varroa Mites from each Honeybee that pass between the brush and the metal receiving tray.

4. The Varroa Mite Control Entrance (VMCE) is lightweight, easy to clean and can be left in place year around.
